(19) United States
(12) Patent Application Publication
(10) Pub. No.: US 2007/0118547 A1
(43) Pub. Date: May 24, 2007

(54) Efficient index versioning in multi-version databases

(76) Inventors: Monish Gupta, Santa Clara, CA (US); Scott D. Lashley, Portland, OR (US); Daniel A. Wood, Fremont, CA (US)

Correspondence Address: Rochelle Lieberman;Lieberman & Brandsdorfer, LLC, 12221 McDonald Chapel Drive, Gaithersburg, MD, 20878-2252, US

(21) Appl. No.: 11/285,340

(22) Filed: Nov. 22, 2005

(51) Int. Cl. G06F 7/00

(52) U.S. Cl. 707/101

(57) ABSTRACT

A method and system are provided for maintaining a database index version. The database index includes a secondary node affiliated with each leaf node of the index. The secondary node stores version information for each leaf node. A pointer in a header section of the leaf node connects the leaf node to the secondary node. In addition, a status list is maintained to identify each transaction. At such time as a scan of a database index is conducted and an index item is returned, a computation is conducted using the transaction identifiers in the secondary node, the delete flag in the leaf node, and the status list contents for the scanning transaction. The computation and associated logic will determine whether to accept or reject an item. The method results in returning a correct version of the item as existed at the time of start of the scanning transaction.

### BACKGROUND OF THE INVENTION

1. Technical Field

This invention relates to database. More specifically, the invention relates to maintaining version information in a database to support efficient query processing using an index.

2. Description of the Prior Art

A database is a collection of information organized to enable a computer program to quickly select desired data. Traditional databases are organized by fields, records, and files. A field is a single piece of information. A record is one complete set of fields. A file is a collection of records. To access information from a database, a collection of programs are used to enable entering, organizing, and selecting data in a database. A list of keys, or keywords, may be provided wherein each key or keyword identifies a set of records. The list of keys or keywords is known as a database index, hereinafter referred to as an index. Database indices make it faster to find specific records and to sort records by the field used to identify the records.

Multi-version databases support multiple users reading and/or writing data at any one time. In a multi-version database system, each write on a data item produces a new version of that data item. A point-in-time version of the database system enables programs reading the database, also known as readers, to see the current committed state of the database as of some point in time in the past, for example the start of their transaction. A Multi-Version database system may maintain version information for table data or for table as well as index data. If the index version is not maintained, a scan of the index can still be done, but getting the correct version of the index keys will require a read of the associated data records.

One prior art solution for versioning index data involves adding new fields to each entry in the index, henceforth referred to as an index item. The added fields are used to chain together all versions of an individual index item. There are drawbacks associated with this approach. The added fields increase the overall size of the index and may increase the number of levels in the associated tree structure. Due to the added versioning information, more index pages will need to be read from the disk to access the same amount of index information. This increases the cost of retrieving index data for all readers.

Another prior art solution is to maintain a transaction list within the page header for each index page. The list contains an entry for each transaction that has made a modification to one or more index items in the page. Each entry in the list contains a pointer to obtain older versions of all index items on the page that were modified by the transaction. Individual index items on the page have a field added to them, to identify the entry in the transaction list for the transaction that modified that item. However, there are limitations associated with use of the transaction list. One limitation is that the transaction list is located within the page header and has a limited amount of space. Once the transaction list is filled, transactions making new modifications may need to be failed or suspended until space can be reclaimed in the transaction list. Another limitation with use of the transaction list is that multiple items in a page may share the same entry in the list. This leads to inefficiency in versioned reads as a reader may have to read older versions of more data than he is interested in.

Therefore, there is a need to apply a technique to an index of a multi-version database that overcomes the limitations associated with the prior art solutions. Such a solution should remove the modification data from the page header and from each index item so as to remove the obstacles associated therewith.

### SUMMARY OF THE INVENTION

This invention comprises a method and system for maintaining version information for a database index.

In one aspect of the invention, a method is provided for maintaining a database index version. An index item is stored in a leaf node of a B-tree. Version information of the index item is stored in a secondary node remote from the B-tree. The leaf node and the secondary node are associated.

In another aspect of the invention, a database is provided with an index item adapted to be stored in a leaf node of a B-tree. Version data of the index item is provided and stored in a secondary node remote from the B-tree. A pointer is provided to connect the leaf node with the secondary node.

In yet another aspect of the invention, an article is provided with a computer useable medium embodying computer usable program code to maintain a database index. The computer program code includes instructions to store an index item in a leaf node of a B-tree. Instructions are also provided to store version information of the index item in a secondary node remote from the B-tree, and to associate the leaf node with the secondary node.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a tree structure for a B-tree index in conjunction with the secondary nodes according to the preferred embodiment of this invention, and is suggested for printing on the first page of the issued patent.

FIG. 2 is a block diagram of a status list.

FIG. 3 is a flow chart illustrating an index scan.

FIG. 4 is a block diagram of a query tool in communication with a database management system.

### DESCRIPTION OF THE PREFERRED EMBODIMENT

### Overview

A database index is represented as a B-tree with each leaf node of the tree representing a page of the database index. A secondary node is dynamically created for each associated leaf node as index items for the respective node are inserted or removed therefrom. A pointer is stored in the header section of each leaf node referencing an associated secondary node. Access to the secondary node is restricted to the associated leaf node. Unique identifiers are provided for each transaction and stored in a secondary node associated with the leaf node that has an amended index item. Similarly, as each transaction is committed, the unique identifier associated with the transaction is stored in a status list maintained in memory on a server. Comparison of identifiers in the secondary node and the status list ensure that a scan of the index produces accurate results.

### Technical Details

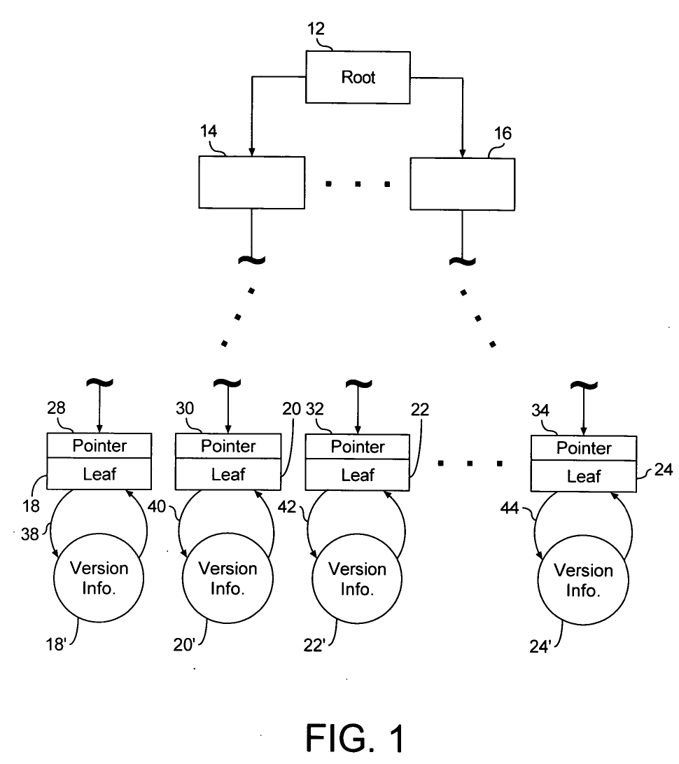

FIG. 1 is a block diagram (10) of a B-tree structure for a database index. A B-tree for organizing database index items is a balanced search tree with a root node, two or more branch nodes, and many leaf nodes. The root node contains pointers to branch nodes; the branch nodes contain pointers to leaf nodes or other branch nodes; and the leaf nodes contains index items and pointers to other leaf node. With respect to FIG. 1, there is a root node (12), intermediate nodes (14) and (16), and leaf nodes (18), (20), (22), and (24). The quantity of intermediate and leaf nodes in the example shown in FIG. 1 are merely an illustrative quantity. The system may be enlarged to include additional nodes, and similarly, the system may be reduced to include fewer nodes. The leaf nodes of the tree store index items of the database and contain data in the form of keywords. A database index is a list of keys or keywords, each of which may identify a record in the database. Indices make it faster to find specific records and to sort records by the index field, i.e. the field used to identify each record. The leaf nodes (18), (20), (22), and (24) of the tree contain keywords that are associated with a specific record in the database. In one embodiment, each leaf node may represent a page in a database index. The intermediate nodes in the tree structure store information to direct a query to an appropriate set of leaf nodes. In addition, each leaf node with at least one modified index item (18), (20), (22), and (24) includes a corresponding secondary node (18′), (20′), (22′) and (24′), wherein each secondary node contains version information for all index keywords in the corresponding leaf node. For example, secondary node (18′) stores version information for leaf node (18), secondary node (20′) stores version information for leaf node (20), secondary node (22′) stores version information for leaf node (22), and secondary node (24′) stores version information for leaf node (24). Each leaf node (18), (20), (22), and (24) contains a pointer (38), (40), (42), and (44) to each secondary node (18′), (20′), (22′), and (24′), respectively. The secondary node is not a part of the B-tree. Access to the secondary node is limited to the respective leaf node through the associated pointer. When a database management system starts running, there are no secondary nodes. At such time as a first update to one of the leaf nodes in the index occurs, a secondary node is allocated by a database server for that specific leaf node and version information for the item being modified is stored in the created secondary node. By storing version information in the secondary node, the version information remains external to the index pages.

As shown in FIG. 1, each leaf node (18), (20), (22), and (24) has a page header (28), (30), (32), and (34), respectively. Each page header (28), (30), (32), and (34) is adapted to store a pointer (38), (40), (42), and (44), respectively, to a corresponding secondary node (18′), (20′), (22′), and (24′). The pointer is stored in a page header of the leaf node. In one embodiment, the page header may include a fixed quantity of bytes. In one embodiment, the pointer in the page header may include one of three values. For example, a null value assigned to the pointer indicates that a secondary node does not exist and version information is not needed since all the data on the associated leaf node was committed prior to the start of any currently active transaction, a negative value assigned to the pointer indicates that version information is needed for the leaf node but it is unavailable due to lack of memory, and a positive value assigned to the pointer indicates version information is needed and available in a corresponding secondary node. Further details pertaining to an update of the pointer value are discussed in the subsequent paragraph.

Once a secondary node for a leaf node has been established, there are limited circumstances in which the removal of the secondary node will occur. Examples of when the secondary node may be removed include, but are not limited to, when the database management system is shut down or when the version information is no longer needed. Whether or not version information is needed is determined by comparing the timestamp in the page header indicating the time of last modification of the page, with the timestamp of the start of oldest active transaction currently executing in the engine. On systems running with low virtual memory, secondary nodes may be released to conserve memory, even when the version information is needed. In such a case, a negative value is stored in the pointer in the page header, indicating that index versions are not available for a time period and table data needs to be read for determining the right version of a key, as discussed above in the prior paragraph. In this state, on every new modification to the associated leaf node, a check is made to determine if the secondary node can be reallocated. The check consists of two conditions. First, memory should be available. Second, the timestamp in the leaf page header should be less than the timestamp at the start of the oldest active transaction in the system. This guarantees that the secondary nodes, when they exist, store all version information required for the associated leaf node. They never store partial version information. If both checks pass, the secondary node is reallocated, and a pointer to it is stored in the leaf page header.

Index items are only inserted or deleted. As such, version information for each index item only needs to reflect one of these two actions. Version information for each index item consists of two transaction identifiers. One identifier is for the transaction that created the index item, and the second identifier is for the transaction that deleted the index item. Each secondary node includes two fields for each index item in the associated leaf node, to store the transaction identifiers. A first field of the secondary node stores the transaction identifier for a transaction inserting a new index item, also known as transaction insert identifier, TI. Each time an item is inserted into a leaf node, the TI of the transaction inserting the new index item is written into the first field of the associated secondary node. A second field of the secondary node stores a transaction deletion identifier, TD. Each time an item is removed from a leaf node, the identifier of the deleting transaction is written into the TD field of the associated secondary node. In addition, when an index item is removed, an indicator is provided to communicate that an item has been marked for removal from the leaf node, i.e. index page. In one embodiment, the indicator may be in the form of a flag which is part of the index item.

The value of the TI and TD identifiers reflect changes to index items. In one embodiment, a counter is maintained on a server in communication with the database management system. At the start of each transaction, the counter is incremented and the value of the incremented counter is assigned to the transaction identifier associated with the transaction. For example, TI may be the value of the global counter at the start of the insertion transaction. Similarly, TD may be the global value of the counter at the time the transaction is removed from an index item. In one embodiment, the counter is a 64 bit monotonically increasing global variable stored in memory and periodically copied into persistent storage of the server. In case of an abnormal shutdown of the database server, the counter can be reconstructed during the recovery process using database log files. Accordingly, a global counter functions in conjunction with the transaction identifier to ensure that each transaction is assigned a unique identifier.

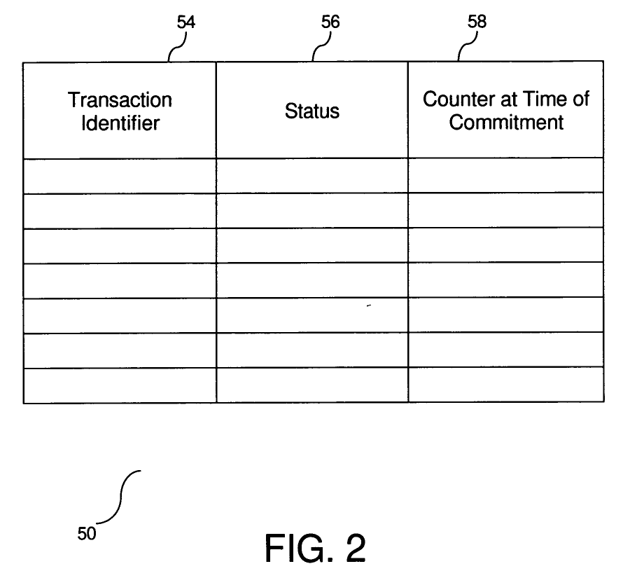

In addition to the transaction identifiers of the secondary node, a status list is maintained on the server. FIG. 2 is a block diagram (50) illustrating an example of a status list. As shown, there are three columns (54), (56), and (58). The first column (54) stores a transaction identifier. The second column (56) stores the status associated with the transaction. The third column (58) stores the value of the global counter at the time the transaction committed its changes to persistent storage. In one embodiment, there are three status values available: committed, active, and aborted. Once a transaction attains a status of committed, the value of the global counter at the time of the commitment is assigned to the transaction. During a scan of the index pages, the status list may be consulted to determine if a transaction is active, committed, or aborted. In one embodiment, the status list may be maintained in memory.

As an index page is scanned in response to a query, it must be determined whether a returned keyword, as reflected in an associated leaf node, has been subject to a change in data. If the delete flag is set, then it must be determined whether the delete transaction was committed before the index scan was initiated. If the delete flag is not set, then it must be determined if the insert transaction was committed before the scan transaction began. A scan of the database index in conjunction with a consult of the status list will determine whether the returned keyword is valid.

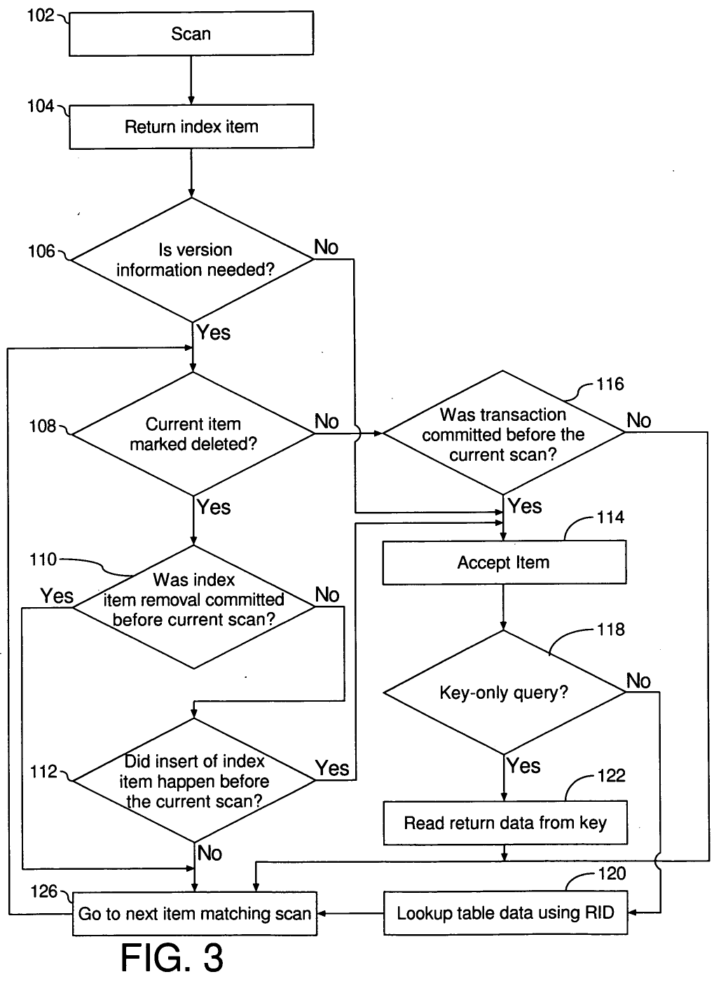

FIG. 3 is a flow chart (100) reflecting an example of an index scan. The first step is to scan the index (102), which will return index data as reflected in a leaf node (104). Thereafter, a test is conducted to determine if version information is required for the index scan (106). In one embodiment, the test at step (106) evaluates the pointer value stored in the header of the leaf node. If a secondary node does not exist for the returned index data or if version information is unavailable for the returned index data, then the index data returned is accepted (114). However, if a secondary node does exist for the returned index data, a test is conducted to determine if the current item returned in the index scan is marked as a deleted item (108). In one embodiment, the determination is made by determining if a delete flag has been set, as reflected in the leaf node. A positive response to the test at step (108) will result in a subsequent test to determine if the transaction which deleted the index item committed the removal of the item before the current scan of the index (110). More specifically, the test at step (110) determines if the item returned in the scan should be present in the current scan since it has been marked as deleted. In one embodiment, the test at step (110) determine if the transaction identifier associated with the deletion in the secondary node is greater than the global counter assigned to the transaction in the status list. A positive response to the test at step (110) will result in proceeding to the next matching item in the index scan (126). However, a negative response to the test at step (110) will result in another test to determine if a transaction which inserted the index item committed the insertion before the current scan of the index (112). In one embodiment, the test at step (112) is a comparison of the transaction identifier in the secondary node with the transaction identifier in the status list. A negative response to the test at step (112) will result in proceeding to the next matching item in the index scan (126). Similarly, a positive response to the test at step (112) will result in accepting the returned index item (114). If a response to the test at step (108) is negative, a test is conducted to determine if the transaction which inserted the index item committed the insertion of the item to persistent storage before the current scan of the index (116). More specifically, the test at step (116) determines if the item returned in the scan should be present in the current scan. In one embodiment, the test at step (116) is a comparison of the insert transaction identifier with the transaction identifier from the status list. A negative response to the test at step (116) will result in proceeding to the next matching item in the index scan (126), and a positive response to the test at step (116) will result in accepting the returned index item (114).

Following an acceptance of the returned index item at step (114), a subsequent test is conducted to determine if the index data can satisfy the query (118). More specifically, the test at step (118) determines if the query requires a look-up of a database record associated with the index item returned from the index scan. A negative response to the test at step (118) will result in a lookup of the associated database record and/or table using a row identifier associated with the transaction identifier (120) followed by proceeding to the next item in the scan (126). The transaction identifier enables the row in the record that has a change to be identified without having to review each item in the index page associated with the leaf node. A positive response to the test at step (118) will follow with a read of the data returned from the index scan (122), followed by proceeding to the next item in the scan (126). Following step (126), the process returns to step (106) to determine the status of the item returned from the index scan. Accordingly, as each returned item in the index scan is returned it is reviewed to determine if this item has been committed to the index.

As shown in FIG. 3, the index scan selects the correct index item version without reading any log records. Each leaf node may represent a page of an index and may contain a plurality of index items. In addition, each leaf node that has experienced a change in an index item is associated with a secondary node, with the secondary node maintaining version information for all amended index items in the leaf node. In one embodiment, the design of the secondary node can be completely independent of the leaf node, with the only constraint being that the entry in the secondary node includes the TI and TD fields for the associated index item, and be able to be looked up efficiently. In one embodiment, the secondary node may contain an array of pointers, each pointer pointing to a linked list. The version information for all items with a given key are stored in a linked list and a pointer to the list is stored in the array. The offset in the array at which the pointer is stored is the same as the offset where the corresponding index items with that key are stored in the associated leaf node. The secondary nodes and leaf nodes maintain pointer to each other. In one embodiment, the secondary node may be protected by a lock on the corresponding leaf node, and access to the secondary node is restricted to the associated leaf node.

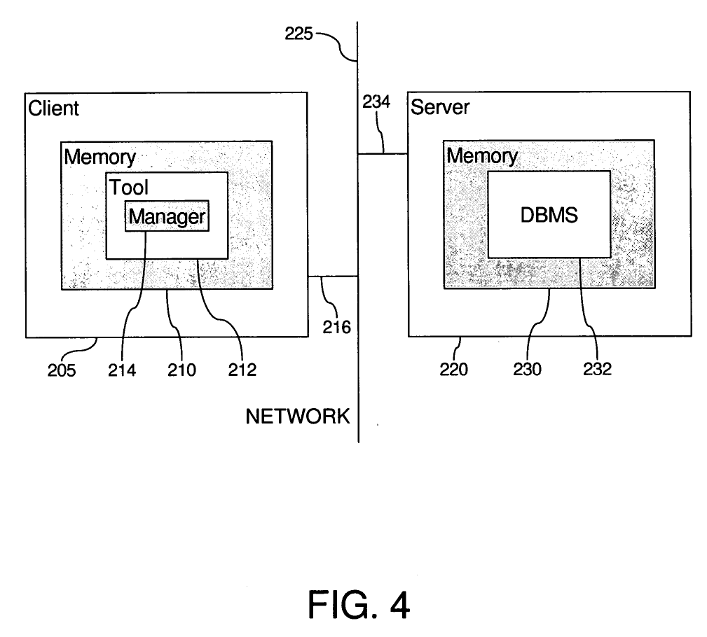

The method for maintaining index version information and scanning index pages may be invoked in the form of a tool utilized by a client machine in communication with a database management system. FIG. 4 is a block diagram (200) of a client machine (205) for use in the system showing components of the database index query tool in communication with a server (220). As shown, the client machine (205) includes memory (210) having a query tool (212) embedded therein. The tool (212) may include a manager (214). The client machine (205) is in communication with a server (220) across a network (225) through a network connection (216). The server (220) includes memory (230) having a database management system (232). The server (220) is in communication with the client (205) across the network (225) through a network connection (234). The database management system (232) is responsive to instructions received by the manager (214) through the database query tool (212) in the client machine (205). In response to a database scan, the manager (214) conducts a comparison of transaction identifiers to determine the current state of a returned index item. Examples of the comparison tests conducted by the manager are outlined in FIG. 3, including the tests at steps (110), (112), and (116).

In one embodiment, the database query tool (212), the manager (214), and the database management system (232) may be software components stored on a computer-readable medium as it contains data in a machine readable format. For the purposes of this description, a computer-useable, computer-readable, and machine readable medium or format can be any apparatus that can contain, store, communicate, propagate, or transport the program for use by or in connection with the instruction execution system, apparatus, or device. Accordingly, the database query tool and database management system component may all be in the form of hardware elements in the computer system or software elements in a computer-readable format or a combination of software and hardware.

### Advantages Over The Prior Art

Version information for index items of a database is maintained external to the index pages. More specifically, version information is stored in a secondary node with access to each secondary node being limited to an associated leaf node. By storing the additional data in the secondary nodes the size of the index remains unchanged as the version information is external to the index. This mitigates performance overhead in traversing the index for all queries. In addition, version information is kept for each modified index item, and is not shared between items. Maintaining version information at a finer granularity allows a query to only access older versions of exactly those items that it is interested in. Furthermore, the basic structure of the index and index items is not altered, allowing easier migration of a non versioned database to be used by a multi-versioning database system.

### Alternative Embodiments

It will be appreciated that, although specific embodiments of the invention have been described herein for purposes of illustration, various modifications may be made without departing from the spirit and scope of the invention. In particular, the design of the secondary node can be implementation specific and should not be limited to the design shown herein. Accordingly, the scope of protection of this invention is limited only by the following claims and their equivalents.

We claim:

1. A method for maintaining a database index version comprising:
storing an index item in a leaf node of a B-tree and storing version information of said index item in a secondary node remote from said B-tree; and
associating said leaf node of said B tree with said secondary node.

2. The method of claim 1, further comprising restricting access to said secondary node to said leaf node.

3. The method of claim 2, wherein the step of restricting access includes said index page having a pointer to designate said secondary node.

4. The method of claim 1, wherein said version information in said secondary node includes an insert identifier for each inserted index item and a delete transaction identifier for each removed index item.

5. The method of claim 1, further comprising comparing said version information in said secondary node with version information stored on a status list to determine if a transaction associated with said index item has been committed.

6. The method of claim 1, wherein said secondary node is an in-memory data structure.

7. A database comprising:
an index item adapted to be stored in a leaf node of a B-tree;
version data of said index item adapted to be stored in a secondary node remote from said B-tree; and
a pointer to connect said leaf node with said secondary node.

8. The database of claim 7, further comprising a manager adapted to restrict access to said secondary node to said leaf node.

9. The database of claim 7, wherein said version data in set secondary node includes an insert transaction identifier for each inserted index item, and a transaction delete identifier field for each removed index item.

10. The database of claim 7, wherein said version information in said secondary node is adapted to be compared with version information stored on a status list to determine if a transaction associated with an index item has been committed.

11. The database of claim 7, further comprising a manager adapted to consult a status list of all transactions in response to return of said index item from an index scan.

12. The database of claim 7, wherein said secondary node is an in-memory data structure.

13. An article comprising:
a computer useable medium embodying computer usable program code for maintaining a database index, said computer program code including:
instructions for storing an index item in a leaf node of a B-tree;
instructions for storing version information of said index item in a secondary node remote from said B-tree; and
instructions for associating said leaf node with said secondary node.

14. The article of claim 13, further comprising instructions for limiting access to said secondary node to said leaf node.

15. The article of claim 14, wherein said instructions code for limiting access includes instructions for designating said secondary node.

16. The article of claim 13, wherein said version information in said secondary node includes an insert identifier for each inserted index item and a delete transaction identifier for each removed index item.

17. The article of claim 13, further comprising instructions for comparing said version information in said secondary node with version information stored on a status list to determine if a transaction associated with an index item has been committed.

18. The article of claim 13, wherein said secondary node is an in-memory data structure.
